(19) United States
(12) Patent Application Publication
(10) Pub. No.: US 2007/0084355 A1
(43) Pub. Date: Apr. 19, 2007

(54) Coffee/tea making container

(76) Inventor: Tzu Yuan Shen, Pu-Li Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/251,814

(22) Filed: Oct. 18, 2005

(51) Int. Cl. A47J 43/14

(52) U.S. Cl. 99/495

(57) ABSTRACT

An improved structure of a container for making tea or coffee is essentially comprised of a body, a bottom lid and a separation container; the body containing an accommodation space with an opening at one end or two opening respectively on both ends, and the opening being covered by the bottom lid; the bottom lid being having a locking unit; an inner thread being provided on the inner wall of the bottom lid, a sealing member being disposed between the locking unit and the inner wall of the bottom lid; and the separation container containing a space having one end disposed with a connection part incorporated to the locking unit from the bottom lid to secure the separation container.

### BACKGROUND OF THE INVENTION

(a) Field of the Invention

The present invention is related to a container for the making of coffee or tea making container, and more particularly to one that is provided with an opening to load water and the separated tea leaves of coffee.

(b) Description of the Prior Art

As illustrated in FIGS. 13 and 14 for a coffee/tea making container of the prior art, the container includes a body 71, an accommodation space 72 in the body 71; an opening is disposed over the accommodation space 72 to permit placement of a filter cup 73 where tealeaves C are put in; and a lid 74 is disposed to the body 71 to cover up the accommodation space 72.

In use, tea leaves C placed into the filter cup 73 and the boiling water is poured into the accommodation space. Those tealeaves C are soaked in the boiling water and get spread up to make a cup of tea.

In making tea, those tealeaves must be allowed to fully spread up in the boiling water. However, the filter cup 73 is loaded to where above the accommodation space 72. The boiling water must be filled up to a level higher than that of those tealeaves C so that they can be fully soaked in the boiling water. When the user pours part of the tea out of the container, the level of the boiling water in the accommodation 72 will be lower than that of the tealeaves C in the filter cup 73 to prevent them C from being soaked in the boiling water.

Furthermore, the opening of the filter cup 73 in the body 71 and that of the body 71 are provided in the same direction. The user could drink up the tea together with those tealeaves C.

As illustrated in FIGS. 15 and 16, a tea/coffee-making container of another prior art designed by the inventor of the present invention is respectively provided with a first opening 81 and a second opening 82 each on both ends of the container, and both openings 81 and 82 are each provided with a top lid 83 and a bottom lid 84 to cover up the container.

A retractable filter cup 85 is provided to the second opening 82 so to restrict tealeaves in the filter cup 85. An opening 86 is provided at the bottom of the filter cup 85 and is located at the same place where the second opening is provided. The perimeter of the opening 86 extends a flange 87 in a diameter greater than that of the second opening 82 so to prevent the filter cup 85 from falling off.

However, upon replacing the tealeaves, the second opening 82 must head upward to first open up the bottom lid 84 to remove the filter cup 85. While removing the filter cup, the residual tea will drop onto the ground to make tealeaves replacement inconvenient.

Furthermore, the production cost is higher and the manufacturing process gets more complicated since a waterproof silica gel cap 88 is provided to the outer circumference of the filter cup 85 to insert onto the outer circumference of the flange 87.

### SUMMARY OF THE INVENTION

The primary purpose of the present invention is to provide an improved construction of a container for making tea or coffee that eliminates those problems encountered by the prior art by having both of a separation container and a bottom lid fixed to each other so that it takes only to remove the bottom lid together with the separation container upon replacing tealeaves. The residual tea in the separation container will drop onto the bottom lid without falling on the ground. The separation container is disposed at where below an accommodation space so to fully soak tealeaves in the boiling water to avoid the annoyance of drinking the tealeaves.

To achieve the purpose, the present invention includes a body, a bottom lid and a separation container. The body includes an accommodation space with one end or both ends provided with an opening, and the bottom lid fits in the opening. A locking unit to secure the separation container is provided on the inner side of the bottom lid and the inner wall of the bottom lid is provided with a thread. A sealing member made of resilient material to check water is disposed between the locking unit and the inner wall of the bottom lid.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is a sectional view of the first preferred embodiment of the present invention.

FIG. 4 is a sectional view of a bottom lid attached to a separation container of the first preferred embodiment of the present invention.

FIG. 5 is a schematic view showing a body of the first preferred embodiment of the present invention is filled up with boiling water to make tea.

FIG. 6 is a perspective view of a second preferred embodiment of the present invention.

FIG. 7 is an exploded view of the second preferred embodiment of the present invention.

FIG. 8 is a sectional view of the second preferred embodiment of the present invention.

FIG. 9 is a schematic view showing a body of the second preferred embodiment of the present invention is filled up with boiling water to make tea.

FIG. 10 is a perspective view of a third preferred embodiment of the present invention.

FIG. 11 is an exploded view of the third preferred embodiment of the present invention.

FIG. 12 is a sectional view of the third preferred embodiment of the present invention.

FIG. 13 is a sectional view showing that a container for making tea or coffer of the prior art is filled up with boiling water to make tea.

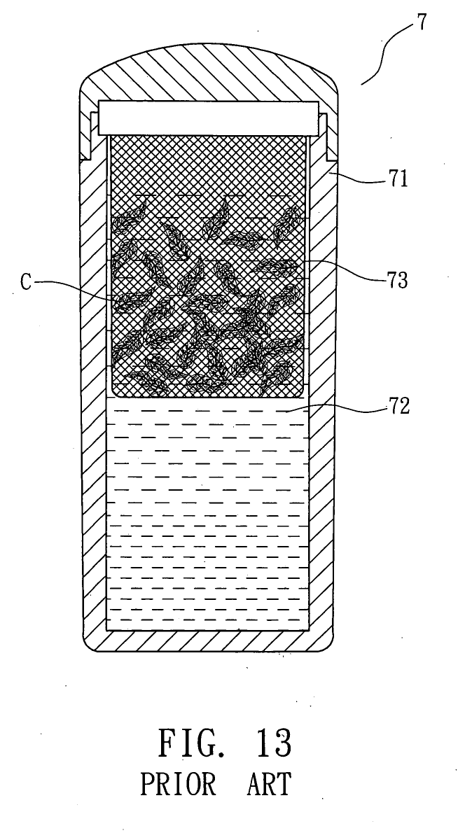

FIG. 14 is schematic view showing the location of tealeaves of the first prior art when the tea is partially consumed.

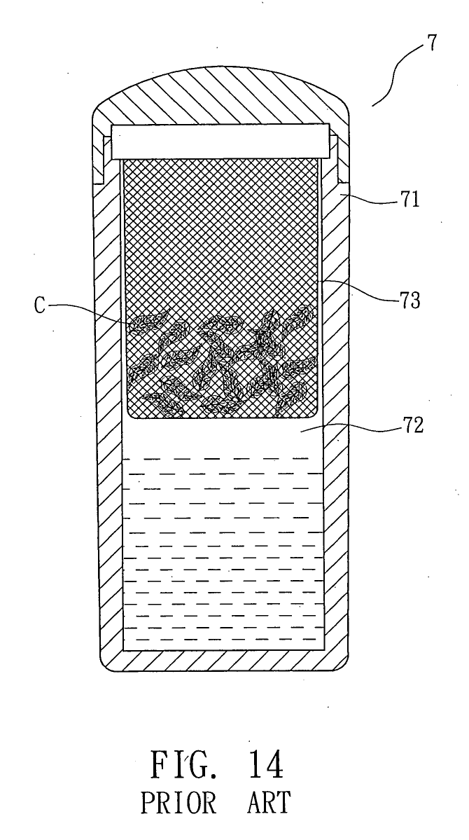

FIG. 15 is an exploded view of another container of the prior art for making tea or coffee.

FIG. 16 is a sectional view of the other container of the prior art for making tea or coffee.

### DETAILED DESCRIPTION OF THE PREFERRED EMBODIMENTS

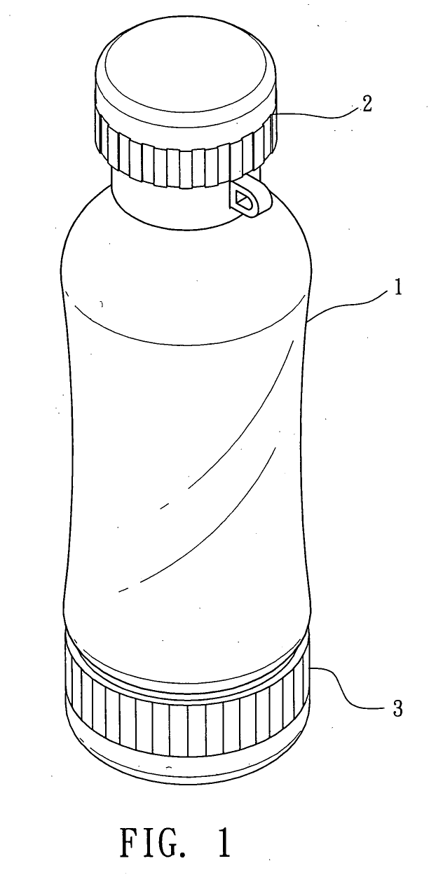

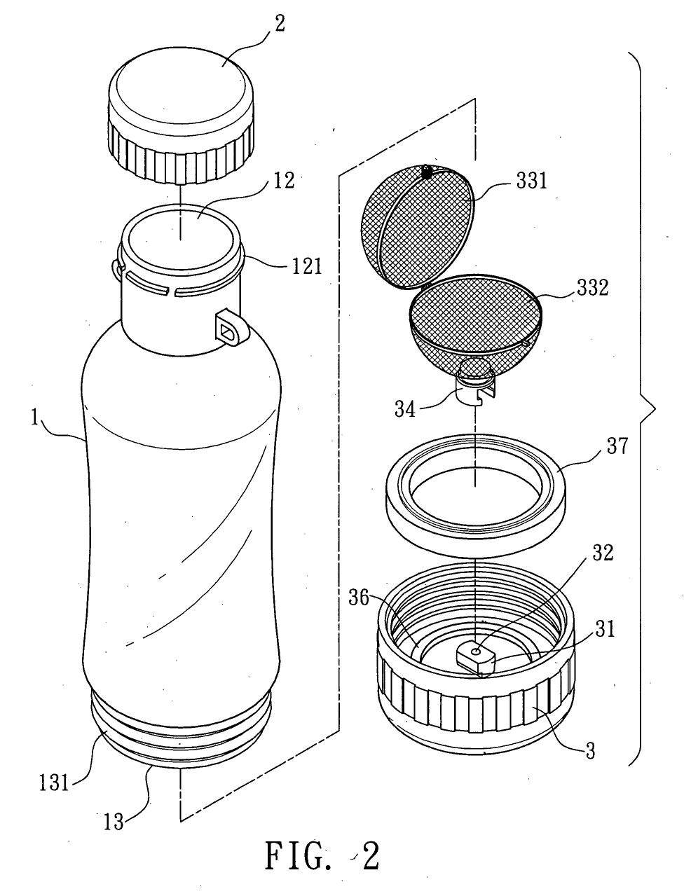

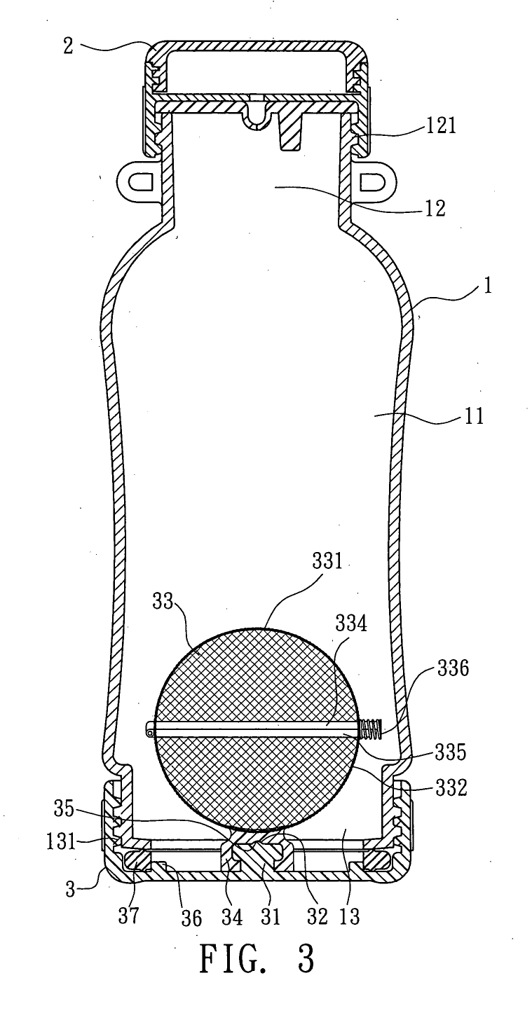

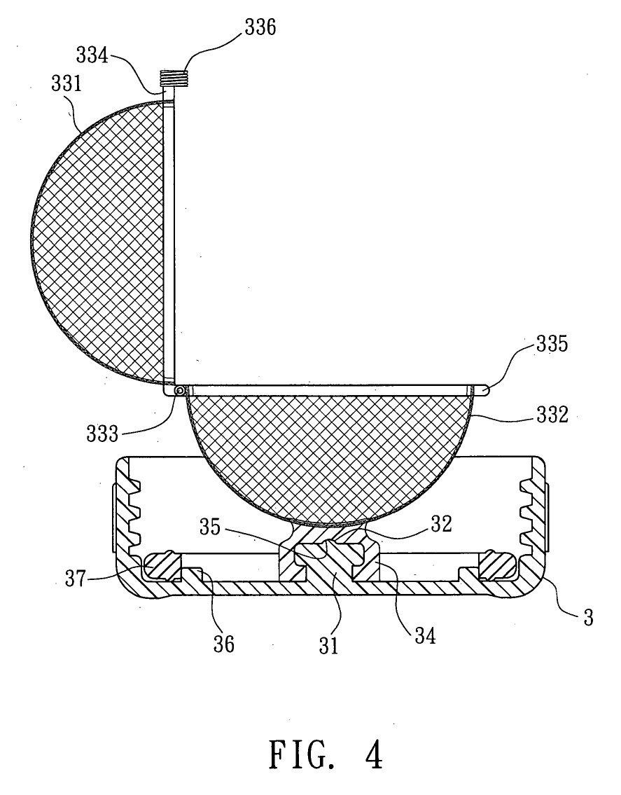

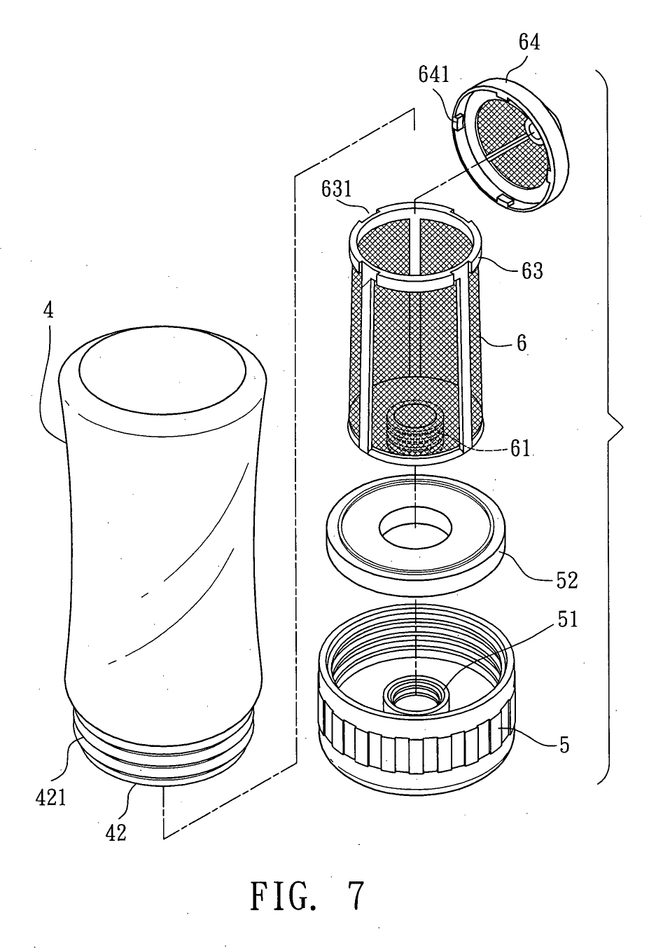

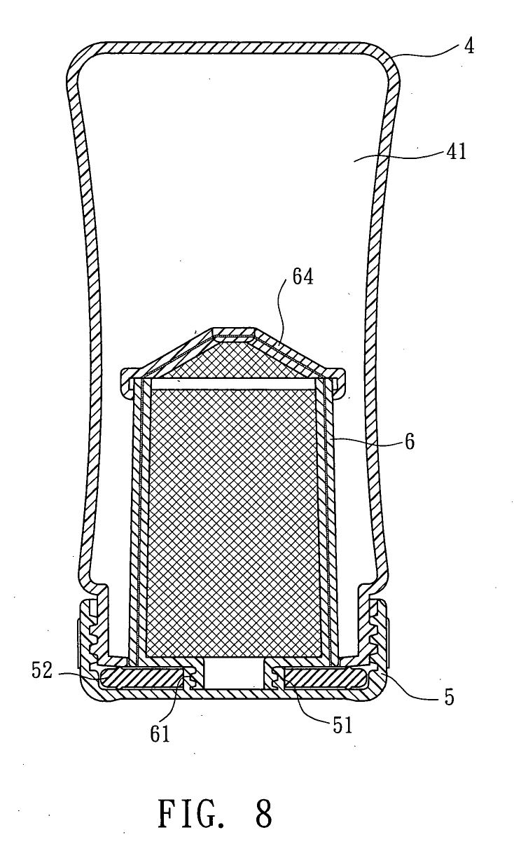

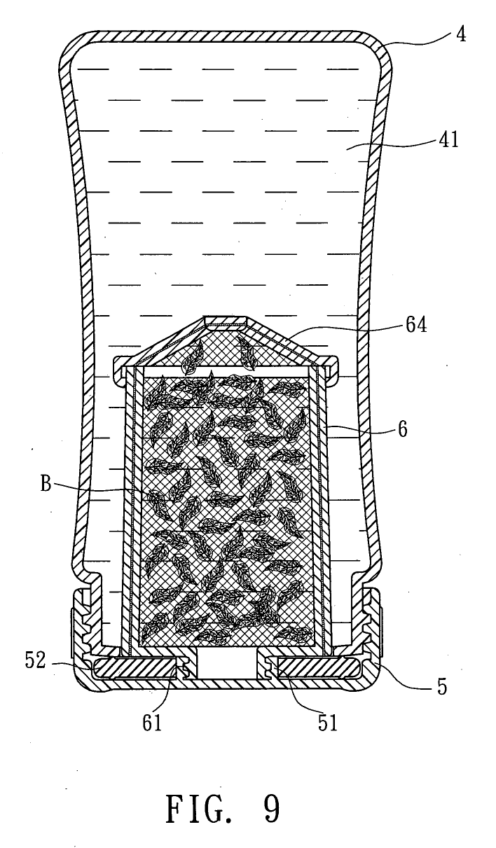

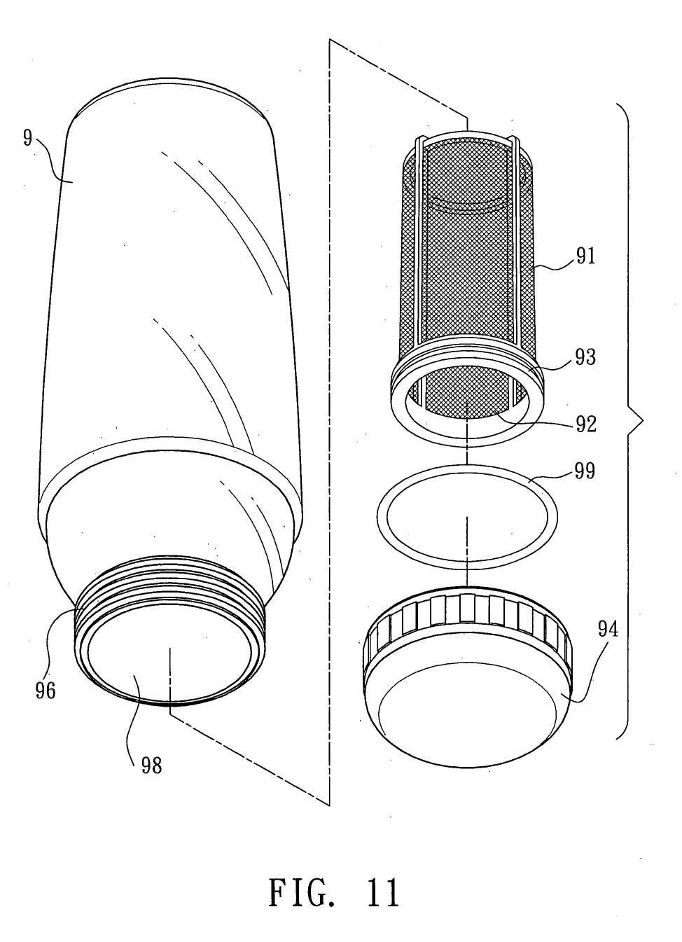

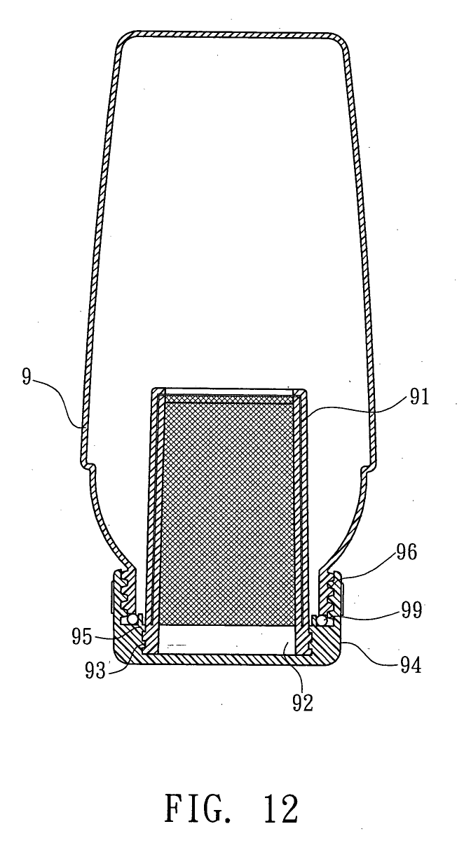

Referring to FIGS. 1 through 12, three preferred embodiments of the present invention are provided here only for the purpose of describing the present invention and shall in no way restrict the claims to be made herein.

As illustrated in FIGS. 1 through 5, a first preferred embodiment of the present invention includes a cylindrical body 11. The body 11 has an accommodation space 11. A first opening 12 and a second opening 13 are respectively provided to both ends of the accommodation space 11. The first opening 12 is disposed at the top end of the body 1 and the second opening 13 is located at the bottom of the body 1. A first outer threaded section 121 and a second outer threaded section 131 are each disposed to the corresponding flange where the body 1 is connected to the first opening 12 and the second opening 13 to respectively be locked by an upper lid 2 and a bottom lid 3 each provided with an inner threaded section so to seal up the accommodation space 11.

In the first preferred embodiment of the present invention, a locking unit is disposed at the center of the lower lid 3. The locking unit relates to a T-shaped saddle 31 with a nipple 32 provided at the center of the top of the saddle 31. The saddle 31 is for the installation of a separation container 33 to secure it in position. The separation container 33 relates to a ball filter cup with one end provided with a T shaped part 34 to connect to the saddle 41. A recess 35 is disposed at the center of the bottom of the T-shaped part 34 for both of the bottom lid 3 and the separation container 33 to slide against each other so to hold in position.

The separation container 33 related to a metal mesh filter cup of the prior art is divided into an upper half 331 and a lower half 332. A pivoting shaft 333 is provided at where on the same side of the upper half 331 and the lower half 332 so to pivot both halves 331, 332. Accordingly, both halves 331, 332 are interconnected to each other while maintaining mobile. On the distal side away from the pivoting shaft, both halves 331, 332 are respectively provided with an upper protrusion 334 and a lower protrusion 335. The upper protrusion 334 is made longer than the lower protrusion 335 while a locking ring 336 is disposed to the terminal of the upper protrusion 334. To load tealeaves A, the locking ring 336 is pushed to the terminal of the longer end so to open up the separation container 33 to load the tealeaves A. Once the separation container 33 is loaded with tealeaves, the locking ring 336 is pushed again to close up both halves 334, 335 for sealing up the ball separation container 33.

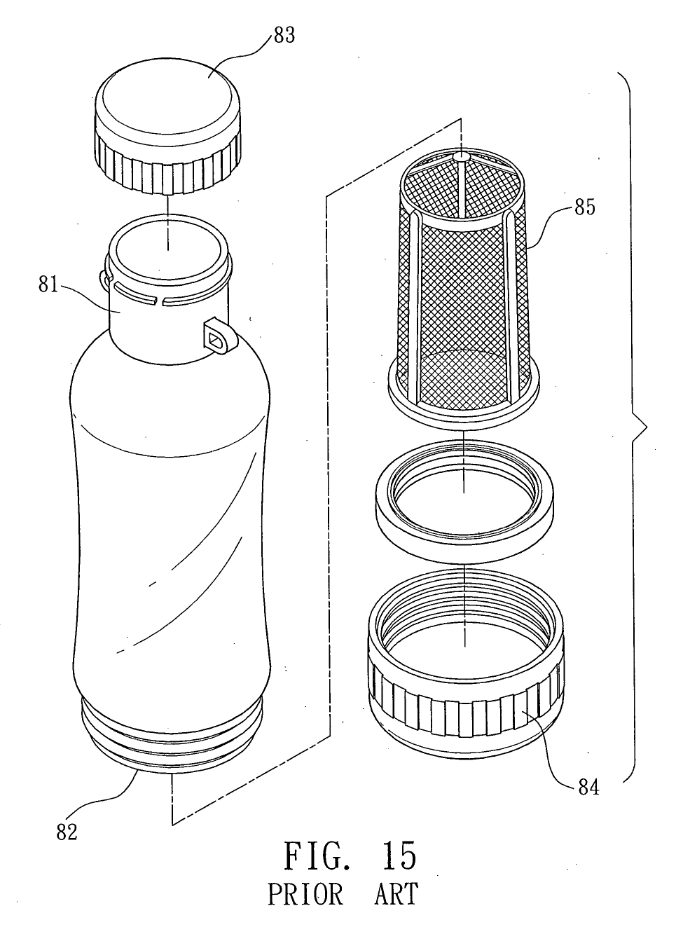

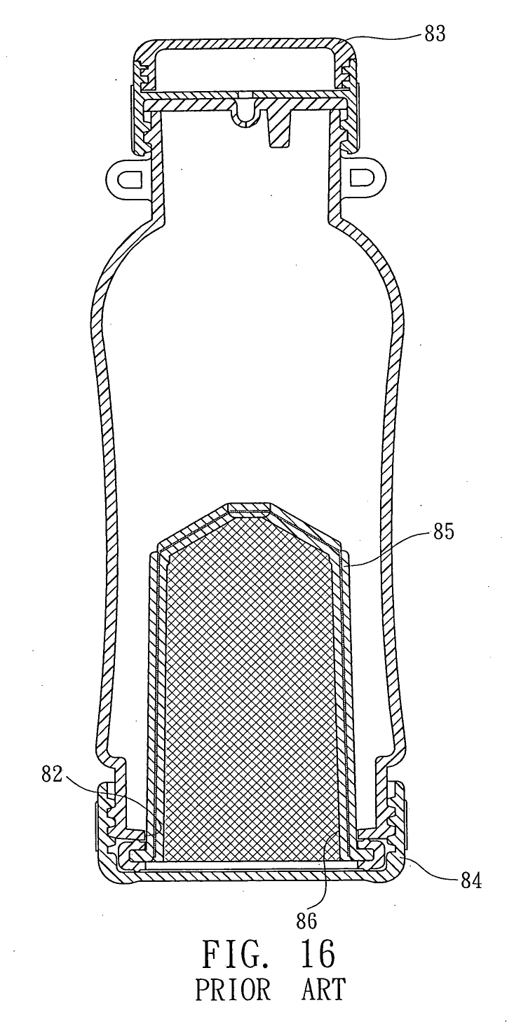

The locking unit for being disposed at the center of the bottom lid is easier to provide sealing up effect than the container of the prior art of the same inventor of the present invention is as illustrated in FIGS. 15 and 16. In the first preferred embodiment, an enclosing wall 36 is provided to protrude in the bottom lid 3. A thin sealing member 37 made of silica gel is disposed between the outer circumference of the wall 36 and the inner circumference of the bottom lid 3. The sealing member 37 ensures that the tea is sealed in the accommodation space 11 and prevents the seepage of residual tea sediments in the second threaded section 131 due to seepage of tea when the bottom lid 3 is locked to the second outer threaded section 131 of the body 1. Meanwhile, the sealing member 37 also provides better watertight result between the body 1 and the bottom lid 3. It allows easier production and lower production cost.

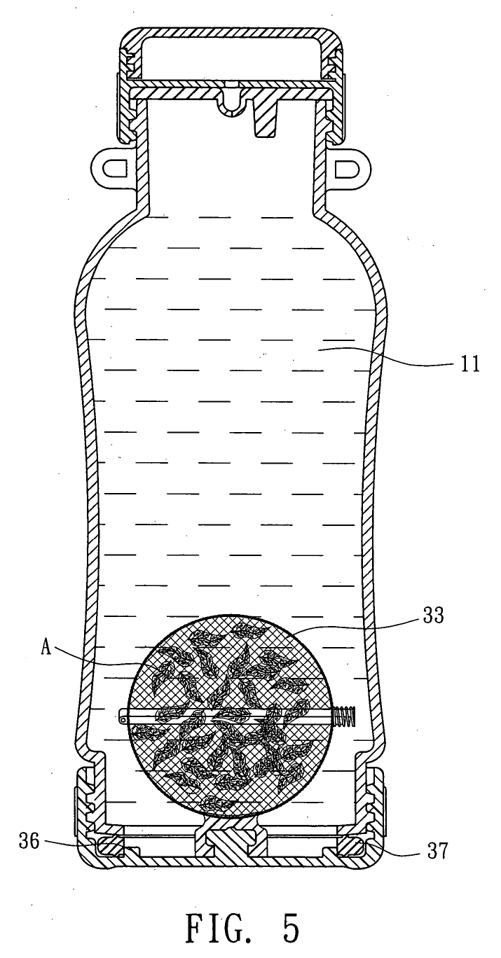

As illustrated in FIG. 5, the separate container 33 in normal condition is located at where below the accommodation space. When the present invention is filled up with water, tealeaves A are fully soaked in the water. Even the user has consumed certain part of the tea there is no risk to stop the tealeaves A from being soaked in the boiling water in the accommodation space 11.

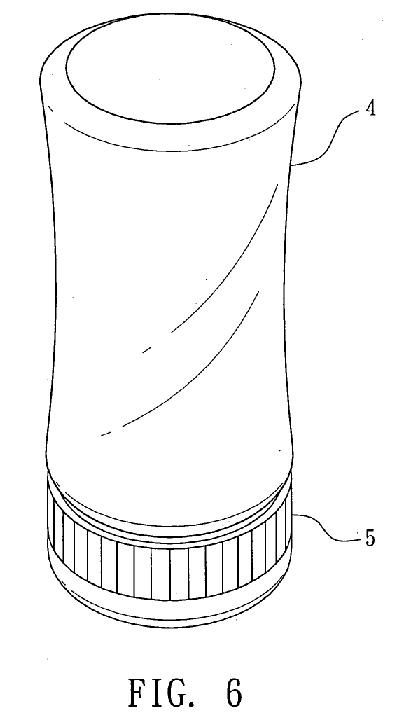

Now referring to FIGS. 6 through 9 for a second preferred embodiment of the present invention, an accommodation space 41 in a body 4 has only one end provided with an opening 42 longitudinally to the body 4. Another end of the body 4 is closed. An outer threaded section 421 is disposed on the outer circumference of the opening 42 to be locked up with a bottom lid 5 containing an inner threaded section to seal up the accommodation space 41.

Another difference of the second preferred embodiment from the first one rests on that a locking unit protruding from the center of the bottom lid 5 related to a column 51 containing an inner thread.

In the second preferred embodiment, a separation container 6 is related to a cylindrical filter cup. The separation container 6 is comprised of a metal mesh 65 and multiple levers 66. One end of the separation container is provided with a cylindrical connection part 61 containing an outer thread. The connection part 61 and the locking unit 51 containing an inner thread from the bottom lid 5 are fastened to each other. An opening 62 is provided on the other end of the separation container 6, a protruding ring 63 disposed at the outer circumference of the opening 62 is provided with four gaps 631 distributed at equal spacing to receiver insertion by a cover 64 provided with four bits 641 protruding inwardly. The cover 64 is comprised of a metal mesh and multiple levers. With the cover 64 inserted to the separation container 6 by engaging those four protruding bits 641 into the corresponding four gaps 631, the separation container 6 is turned clockwise or counter-clockwise to such extent that those four protruding bits 641 of the cover 64 stay away from their corresponding gaps 631 of the separation container, the cover 64 is locked in position to restrict tealeaves B to stay in the separation container 6.

Of course, a sealing member 52 is disposed between the outer circumference of the locking unit 51 at the center of the bottom lid 5 and the inner circumference of the outer wall of the bottom lid 5 for the bottom lid 5 when locked to the body 4 to seal up the tea in the accommodation space while providing better watertight effect between the body 4 and the bottom lid 5.

Furthermore, the locking unit on the bottom lid 5 is provided with an outer thread and the connection part 61 of the separation container 6 is provided with an inner thread.

The first preferred embodiment is operative in conjunction with a single opening while the second preferred embodiment is also operative in conjunction with both ends of the body each provided with an opening. The body of the present invention is operative with one end or both ends of its body provided with one or two openings.

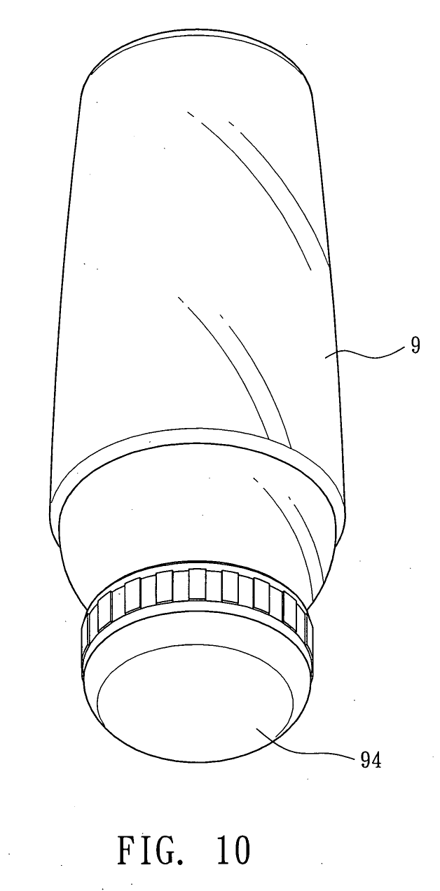

As illustrated in FIGS. 10 through 12, a third preferred embodiment of the present invention has an opening 98 provided to a body 9 and covered up with a bottom lid 94 similar to that found with the second preferred embodiment.

What differs from the second preferred embodiment is that an opening 92 is disposed to a separation container of the third preferred embodiment. A connection part 93 with an outer thread is disposed at the outer circumference of the opening to be incorporated with a locking unit 95 disposed on the bottom lid 94. The locking unit 95 similar to the locking unit 51 of the second preferred embodiment is provided with an inner thread 951while the inner diameter of the locking unit 95 of the third preferred embodiment is greater than that of the locking unit 51 of the second preferred embodiment.

Accordingly, after the locking unit 95 is incorporated with the connection part 93 from the separation container 91, both of the separation container 91 and the locking unit 95 are locked into the opening 98 of the body 9 provided with an outer thread 96. Meanwhile, a sealing member 99 is provided between the inner wall of the bottom lid 94 and the locking unit 95. The sealing member 99 related to an O-ring packed by the body 9 to achieve the similar purpose provided by the first or the second preferred embodiment.

The prevent invention provides an improved structure of a container for making tea or coffee, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

1. An improved structure of a container for making tea or coffee comprising:
a body having at least one opening at one end thereof and an accommodation space within the body extending between opposing upper and bottom ends of the body;
at least one lid releasably coupled to the one end of the body to form a closure for the opening thereat, the lid having a locking unit coupled to an inner wall thereof;
a sealing member made of a resilient material disposed adjacent the inner wall of the lid to form a seal between the one end of the body and the lid; and
a separation container disposed within the accommodation space and releasably coupled to the lid, the separation container having (a) a cavity for receiving a beverage component, (b) a connection part extending from a first portion of the separation container and being releasably coupled to the locking unit of the lid, (c) a second portion of the separation container at least partially separable from the first portion of the separation container while coupled to the lid to provide open communication with the cavity, and (d) a fastening unit for releasably securing the second portion of the separation container to the first portion of the separation container.

2. The improved structure of a container for making tea or coffee as claimed in claim 1, wherein the locking unit is disposed at the center of the lid; the locking unit having a T-shaped saddle; a nipple being disposed at a center of a top of the saddle; the connection part of the separation container having a T-shaped recess for receiving the T-shaped saddle; the recess being disposed at a center of a bottom of the connection part.

3. The improved structure of a container for making tea or coffee as claimed in claim 1, wherein the locking unit is disposed at a center of the lid; the locking unit having a screw thread corresponding to a mating screw thread the connection part of the separation container.

4. The improved structure of a container for making tea or coffee as claimed in claim 3, wherein the first portion of the separation container is comprised of a metal mesh and multiple ribs; the connection part of the separation container being disposed at one end and being provided with a first opening and an outer thread disposed on an outer surface thereof; the locking unit being disposed at the center of the bottom lid and having an inner thread fastened to the connection part; another end of the separation container being provided with a second opening, a protruding ring being disposed at an outer circumference of the other end and having four gaps equally distributed therein, the second portion of the separation container being a cover with an outer circumference having four bits protruding inwardly into the gaps of the protruding ring; the cover being comprised of a metal mesh and multiple ribs; wherein when the cover is placed onto the separation container and turned clockwise or counter-clockwise the four protruding bits engage with the four gaps of the separation container to secure the cover in position.

5-6. (canceled)
